(19) United States
(12) Patent Application Publication
(10) Pub. No.: US 2007/0085338 A1
(43) Pub. Date: Apr. 19, 2007

(54) Frangible card carrier with removable layer provided in a temporary laminated assembly

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/231,017

(22) Filed: Sep. 20, 2005

(51) Int. Cl. B42D 15/00

(52) U.S. Cl. 283/109

(57) ABSTRACT

The present invention relates to a temporary card carrier laminate that is produced by using a substantially rigid card base that is coated with a curable material. The coating is used to create a bond between the card base and an over laminate that is readily broken upon application of sufficient tearing pressure. The over laminate is then left substantially free of any adhesive residue after it is removed from the laminate assembly. The temporary laminate is produced through a unique process that includes preparing an over laminate web by printing, then cutting the web into individual segments and placing each of the segments on individual card blanks and then curing the card carrier assemblies. The web and/or card base are printed with indicia at a resolution of greater than about 150 lines per inch.

### CROSS-REFERENCES TO RELATED APPLICATIONS

None.

### FIELD OF THE INVENTION

The present invention is found in the field of consumer card products particularly those used in redemption, gift and debit card applications. More specifically, the present invention is directed to a temporarily laminated configuration in which a substantially rigid base card element is provided with an intermediate frangible layer and a removable over laminate that is used in the gift, debit or redemption program. The over laminate portion is preferably at least coextensive with the sides and edges of the supporting base element and is affixedly held in position to the base element by a cured frangible coating that upon application of tearing pressure causes the over laminate to separate from the underlying base element leaving substantially no adhesive residue on the over laminate portion after removal.

### BACKGROUND OF THE INVENTION

There are a plethora of office products, business forms and stationery items available in the market today and yet with this inordinately large selection of offerings and permutations, there remains a continuing need to develop new products due to changes in technology, societal trends, diversification and new information handling needs.

Cards, including plastic cards and tags, are generally well known and come in a variety of sizes and shapes depending on the particular needs of the issuer or end user. Wallet sized cards have become fairly common place and due to the popularity of such pieces and the articles have been used for identification cards, credit card, key cards and a host of other applications. Wallet sized cards have dimensions of about 3 ⅜ inches wide to about 2 ⅛ inches in length.

Gift cards have also become fairly regularly used and may often be provided with colorful graphics and included along with a greeting card or other presentation vehicle which may similarly contain graphics and pictorial representations of the gift giving event that accompanies the exchange of the card product. The card may be placed loosely within the card; held in place by a spot of adhesive; have some cut outs to hold comers of the card; or may use some other means to hold the card that does not detract from the appearance of the overall gift package.

Hospitality cards, such as those used in clubs, hotels, restaurants and the like often may have some rudimentary generic or static printing provided on a first surface and a magnetic stripe provided on the back surface. The magnetic stripe is more than likely used to help in gaining access to the establishment such as by opening a door or other entryway.

Labels are also generally well known in various industries for their use and application in identifying goods. Label or pressure sensitive adhesive assemblies, as they are generally known, are typically readily available and can be provided in a number of suitable formats or arrangements. However, labels may not be desirable for all applications particularly where any exposed adhesive is a concern. In those instances when the adhesive may be exposed, the adhesive can come into contact with other surfaces to which the label or adhesive was not intended to adhere, touch or bond. In addition, even in those situations where adhesive contact is expected, the labels may leave behind adhesive residue on the initial surface to which the label was applied leaving the customer with an unwanted tacky substance which may mar, distort or otherwise take away from the appearance of the item from which the label has been removed. In addition, if adhesive is removed along with a separable element, the adhesive must still be dealt with and covered or deadened to prevent the adhesive from coming into contact with unintended surfaces.

Self-laminating adhesive products may overcome some of the drawbacks encountered with the use of labels, but require additional handling in order to complete the construction of the identification piece of the subject being identified. For example, a self-laminating card typically requires the user to align the component parts of the assembly (usually by folding over one portion on to the other) in order to finish affixing the assembly prior to use. If the alignment is not completely accurate, then there may be adhesive exposed in the assembly, leading to the problems identified above of unwanted adhesive contact. In addition, improper alignment may take away from other aspects of the assembly or the merchandise to which it has been applied. Moreover, such self laminating assemblies require the additional user interface (folding, alignment, etc.), to form or create the self laminating arrangement, thus requiring additional labor which proportionately increases the cost of application this ultimately is likely passed along to the consumer.

So called “piggy back” pressure sensitive products are also known and generally consist of a substrate to which another label is adhesive applied to the surface of the substrate. The adhesive is generally a removable or repositionable adhesive which allows the piggy back assembly to be readily removed without tearing. Alternatively, in such assemblies only a base portion of the piggy back piece is provided with adhesive which is permanently adhered to the substrate and a perforation permits the remaining portion of the assembly to be removed. In the former situation, one still must address the exposed adhesive as discussed above and in the latter situation; the construction requires an extra length of material to be used in the construction of the assembly.

Another piggy back type of construction includes creating a pressure sensitive assembly that consists of a release liner on to which a series of removable stickers or labels are placed. The liner is then adhered to the surface of a card or other suitable substrate. One drawback with this construction is that the face of the card or substrate becomes unusable as a communication medium as the face is concealed by the liner. In addition, there is expense involved in first preparing the pressure sensitive construction before the construction can be mounted to the surface of the card. An exemplary assembly is shown in U.S. Pat. No. ______.

The use of dry adhesive technology or so called dry tags, has been developed and typically includes the use of an adhesive coating that is applied to the back of a layer or sheet and the adhesive coating is then treated so that the coating will bond to the layer or to a carrier assembly. Then upon the application of sufficient force to the layer that the user desires to remove, in theory, the layer is supposed to release cleanly from the laminate without adhesive residue being present, visibly or otherwise, as the adhesive is supposed to have dried due to the previous treatment step.

However, such products unfortunately still can suffer from a number of drawbacks and disadvantages in that if the bond between the layers of the material is to aggressive or strong then upon separation, for example through peeling or delaminating force, the portions or components of the form will tear or rip apart thereby destroying the functionality of the form construction. That is, the portions will suffer from “fiber tear” where a portion (usually the face or back) of one layer detaches or delaminates and remains with the other layer thus creating the appearance of ripping or a defective tag.

This creates an undesirable effect, in that it makes the removed layer appear as if it had been tampered with because of the appearance of the torn fiber. Moreover, the layer may no longer be readily adaptable to receiving additional information due to the surface deformations or potentially be suitable for use such as in a redemption or gift program.

The creation of such dry adhesive technology products can also be expensive in that manufacturing process for this type of technology has heretofore typically required a plurality of steps in order to create a sufficient seal that will bind the two layers together. In such manufacturing processes, a sheet or web of material is coated with a layer of a curable coating, typically an adhesive coating. The coating, which is exposed, is then subjected to a direct curing treatment and shortly thereafter, a second sheet or web is applied over the first sheet or web creating a sandwich or laminate and thus covering the coating layer.

The difficulty with this process is that once the curing energy has been applied directly to the coating layer, there is only a finite amount of time in which to apply the second sheet or web. If the second sheet or web is applied prematurely, the coating will not properly cure and the sheets will not be adequately laminated together and hence the sheets may splay or shift out of alignment with one another, which is referred to as a “loose” arrangement. This loose arrangement can subsequently cause printer jams and jamming of other processing equipment as the edges of one or more sheets can catch on the edges of the equipment.

Over curing of the exposed coating material can also occur and may result in a “tight” arrangement in which the sheets when pulled apart will suffer from fiber tear that is a portion of one sheet will be torn off and left behind on the other sheet, generally making the sheets unusable.

If one waits too long to apply the second sheet or web, the coating can then dry out and the formation of a bond between the two sheets is likely impossible. Thus, if the process and timing are not closely monitored, the sheets, webs and coatings can be wasted not to mention the time the operator spent in preparing the product.

In a second prior art process for making dry technology products, a first sheet or web is coated with a silicone layer to which a cold or other curable glue is then applied and remains exposed for subsequent treatment. The curable adhesive is then treated and a second sheet or web is applied over the glue to create a laminate. Once the glue is fully cured, then the sheets may be separated as the adhesive is supposed to be dry and hence cannot contaminate surrounding areas through unwanted adhesive contact. However, this process in addition to the difficulties enumerated above with respect to careful control of the timing of the curing and placement of the webs also suffers from the drawback in that it requires additional materials, such as a silicone coated first liner and as such can be more costly to produce.

A still further dry technology type arrangement is provided in U.S. Pat. No. 6,569,280 in which a card is placed into a portion of a business form, and a patch with an adhesive coating is applied to hold the card in position. The adhesive coating is then treated with electromagnetic radiation through the card or patch to cure the adhesive. However, the card and patch need to be water vapor impermeable in order for the sealing arrangement to work. With business forms, it is very difficult to maintain constant conditions for the business form from manufacture, during shipment and handling to use by the end user. As such, an arrangement would not lend itself to multiple applications, particularly as they relate to apparel or textile uses.

In addition, the foregoing arrangement is a relatively complex assembly requiring a business form, card, patch and coating to be applied in a particular sequence. Once formed, the assembly must still undergo further steps such as folding and sealing in order for the assembly to be delivered to the intended recipient. In addition, such a construction would also likely not be printable in a non-impact printer due to the difficulties associated with the “hump” or bump created by the raised area of the card/patch.

Publications, patents and patent applications are referred to throughout this disclosure. All references cited herein are hereby incorporated by reference.

What is needed is a simple, economically feasible, temporarily laminated card carrier assembly that permits the ready printing of both static and variable information as well as one that enables the easy separation of components from one another and without further handling and which overcomes the drawbacks referenced above by enabling the card carrier assembly to be formed in situ through the use of passing the curing energy directly through one of the sheets or webs in the laminated construction.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present specification describes a temporary card carrier intermediate in which a removable over laminate is provided on a rigid card base. The two layers are secured together through use of a coating that is curable in situ and which upon separation of the layers will yield an over laminate layer that is substantially free of adhesive residue.

The card carrier laminate of the present invention may be used for a variety of purposes including customer redemption programs, loyalty card offerings, debit, membership opportunities, product and discount coupons and a number of other applications in which it may be desirable to have a removable portion that can be processed without encountering prior art problems, such as exposed adhesive, as described above.

In one exemplary embodiment, a temporarily laminated card carrier assembly is described and includes a substantially rigid card carrier base, such as a plastic card having dimensions of about 2 ¼ inches by about 3 ½ inches. The base has first and second faces and first and second longitudinally extending sides and first and second transversely extending edges. The second face of the card base is provided with printed indicia, which may include personalized or static information. The card base, second face or bottom face may also be provided with a magnetic strip that preferably will run parallel to the first and second longitudinally extending sides.

In the presently described embodiment, a coating that is curable in situ is applied to the first face of the substantially rigid base. The coating is applied so as to be substantially coextensive with the first and second transversely extending edges and first and second longitudinally extending sides of the card base and is preferably curable through the use of ultraviolet radiation.

A removable over laminate that has top and bottom faces, first and second longitudinally extending sides and first and second transversely extending edges is provided and sized and configured to be substantially equivalent to the surface of the rigid card base. The top face of the over laminate is provided with printed indicia, which may be personalized indicia, static or both, and each of the sides and edges of the over laminate are at least coextensive with the first and second longitudinally extending sides and first and second transversely extending edges of the substantially rigid base. The over laminate is applied over the curable coating to form an intermediate laminate assembly with the substantially rigid base. The removable over laminate is substantially free of any adhesive residue.

The over laminate or top layer may also be provided with first and second lines of weakness the will run parallel to one of the first and second longitudinally extending sides and first and second transversely extending edges. Third and fourth lines of weakness may also be provided and will generally run perpendicular to the first and second lines of weakness and preferably parallel to the first and second transversely extending edges of the over laminate.

In yet another exemplary embodiment, a laminated card carrier assembly is produced in accordance with the following process and includes the steps of initially providing a substantially rigid base. The base has top and bottom faces, first and second transversely extending edges and first and second longitudinally extending sides. A curable, frangible coating is applied to at least a portion of the top face of the rigid base.

Next, an over laminate is produced by advancing a web of material in a first direction, the web having first and second faces and imaging is applied to the first face of the web with a high resolution image having greater than 150 lines per inch. The web is then cut into discrete segments and each of the segments are placed into a feeder mechanism. Each one of the segments are placed sequentially on the rigid base and over the coating and the coating is cured in situ by applying curing energy through the segment to create a temporarily laminated card carrier assembly having a substantially adhesive free removable over laminate.

In a yet still further embodiment of the presently described invention, an intermediate card shaped temporary laminate is described and includes a card having top and bottom faces, first and second longitudinally extending sides and first and second transversely extending ends, with printing applied to the bottom face of the card. A coating curable in situ is applied to the top face of the card and between the first and second longitudinally extending sides and first and second transversely extending edges. The coating covers substantially all of the top face.

A preprinted over laminate that has indicia provided on a top face with the printing produced in a resolution greater than about 150 lines per inch is provided. The over laminate has first and second longitudinally extending sides and first and second transversely extending edges. The first and second transversely extending sides and first and second longitudinally extending edges of the over laminate are placed in substantial registry with the first and second longitudinally extending sides and first and second transversely extending edges of the card with the curable coating temporarily bonding the over laminate to the card.

Through the practice of the present invention, card carrier laminates can be produced through an effective and economical process which can be used to create attractive promotional and marketing pieces for a number of uses.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the assembled card carrier laminate prepared in accordance with the present invention;

FIG. 2 shows a side elevation of the assembled card carrier laminate prepared in accordance with the present invention;

FIG. 3 provides a block diagram showing an exemplary method used in preparing the card carrier laminate;

FIG. 4 illustrates the back side of the rigid base of the card carrier intermediate;

FIG. 5 depicts the peeling away of the over laminate from the card carrier assembly and showing the frangible bond; and

FIG. 6 shows a front view of the card carrier assembly in which a portion of the over laminate has been peeled away revealing printing on the face of the card base.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been discovered, that unique card carrier, intermediate laminate assemblies can be created in-situ in a straight forward and simple process through the use of a coating compound that can be cured in situ. The temporary card carrier laminate described in the present application enables treatment energy, such as ultraviolet energy (“UV”) to be passed directly through one or more of the layers that make up the card carrier assembly and creates the final, temporary laminated arrangement. In addition, and surprisingly it has been found that the strength of the curing compound can also be manipulated through the type and intensity of the energy that is permitted to be passed through the one or more layers, sheets or webs of the business form assembly. The present assembly is created when it is in a final configuration and does not require the supplemental steps of curing or sealing in order to further process the product prior to distribution to an end user or recipient.

Through use of the present invention, a vast array of over laminates can be placed over the card base substrate thereby creating a versatile intermediate laminate assembly. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional applicators.

As used herein, the term “templates”, “segment”, “ribbon” or “element” refers to a particular size, configuration or arrangement of a piece. For example, if the template or segment is an over laminate to be used as a coupon, the over laminate will preferably have a size of 2 ¼″ −3 ½″, or any other sizes that may be customarily produced.

The term “personalized information” refers to information that is printed or imaged onto a substrate, which is generally variable or unique and which may change from document to document or segment to segment, so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturer or supplier wishes to convey to an end user or customer of the offering.

The term “intermediate” as used herein, refers to a product that undergoes one or more processing steps prior to the intermediate reaching a final condition, that of being ready for end use or application. Typically, a product, such as with the present invention, is provided in an initial intermediate condition so that a user can add or manipulate the intermediate to create the final or desired end product, such as by printing through a non-impact printer.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

An exemplary feeder or placer mechanism that may be used in connection with placing segments on the card base is available from Maverick® available from In-Line Automation of Minneapolis, Minn. The exemplary unit may use a vacuum cylinder to take the segments from the hopper and then deposit the individual segments sequentially on the surface of the card over the coating in a machine direction. It should be understood, that the invention is not limited by the type of placer mechanism used in the present example.

The manufacturing process that utilizes the foregoing system may be described in application Ser. No. 11/135,481 filed May 23, 2005, Ser. No. 11/135,179 filed May 23, 2005 and Ser. No. 11/135,131 filed May 23, 2005 assigned to the current assignee as the present invention and the disclosures of each of which including that found in the claims is incorporated herein by reference.

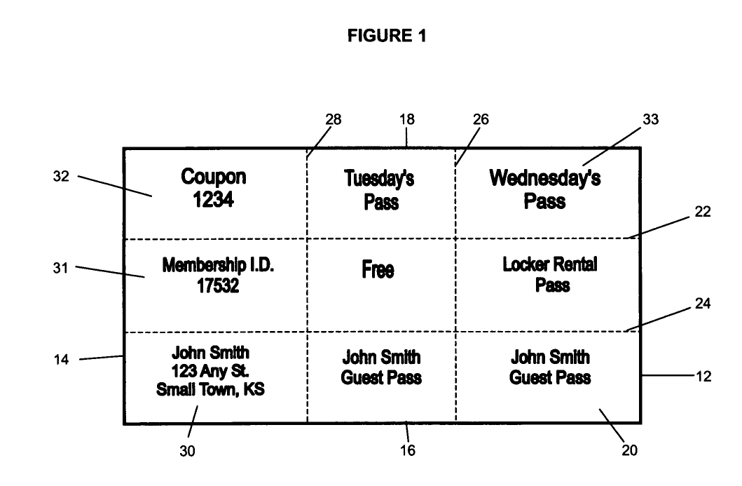

Reference is now direct to FIG. 1 of the presently described embodiment which shows a front view of a card carrier assembly 10. The card carrier 10 has first and second longitudinally extending sides 12 and 14 and first and second transversely extending edges 16 and 18. FIG. 1 shows the over laminate 20 juxtaposed over the card base and running generally coextensive with the area of the card. That is, the edges and sides of the over laminate 20 are in line with the sides and edges of the card base.

The over laminate 20 is shown with first and second lines of weakness 22 and 24 which run substantially parallel to the first and second longitudinally extending sides 16 and 18. In addition, third and fourth lines of weakness 26 and 28 are provided in the over laminate 20 and run perpendicular to the first and second lines of weakness 22 and 24 and parallel to the first and second transversely extending edges 26 and 28.

The over laminate of the present invention can range from a transparent to translucent to a semi opaque sheet of material that may be derived from cellulosic materials such as paper, glassine, wax paper, and the like to synthetic materials that will enable the treatment energy to pass through the layer so as to be able to cure the coating in-situ. The thickness of the over laminate can range from about 1 mil up to about 7 mils and more preferably between about 2 mils to about 3 mils with about 2.2 mils to about 2.5 mils being preferred. One exemplary sheet suitable for use in the present invention that enables sufficient energy to pass through is UV230 from Nicolet Paper of Depere, Wis. Another exemplary layer is a machine finished 400MF available from Wassau Paper of Wassua, Wis. However, standard twenty pound bond paper may also be used and is suitable for passing sufficient energy through to enable the curing of the UV curable coating through the paper.

The over laminate 20 is shown with a number of printed areas some of which are printed with personalized information, areas 30 and 31 and others of which are printed with static or fixed information 32 and 33. That is, some areas may be printed with information that is directly relevant or specific to the recipient while other areas may be printed with information that will be useable for all recipients.

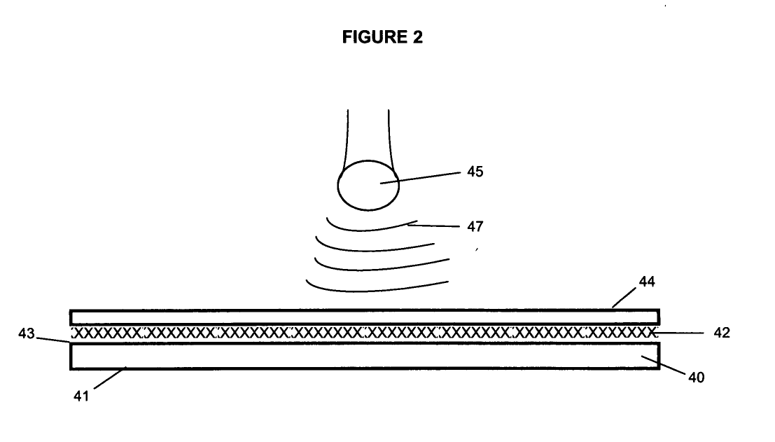

Turning now to FIG. 2 of the present invention a side view of the card carrier assembly is provided and includes a card base layer 40 which has first and second surfaces 41 and 43 and a coating 42 applied over the second face 43 of the base layer. Preferably, the base layer 40 will be substantially rigid and generally planar and the coating 42 will be applied so as to substantially cover the surface of face 43 and extend to each of the sides and edges of the card base. Over the top of the coating 42 an over laminate sheet 44 is applied. Curing of the coating 42 is accomplished preferably through a UV source 45 from which radiation waves 47 penetrate the top layer or over laminate sheet 44 to harden the coating and bond the card layer 40 to the over laminate 44 creating a frangible bond that will rupture upon application of sufficient tearing pressure or forces.

An exemplary coating that may be processed in situ and used in the present invention is a UV curable coating distributed under the product name FT30LI and is available from Northwest Coatings Corp., Oak Creek, Wis. 53154 and is composed of various acrylate monomers and oligomers. The coating maintains a boiling point of greater than 200° C., a vapor density of greater than 1 (air =1), an evaporation rate of greater than 1 (n-Butyle Acetate =1) and a vapor pressure of less than 1 (MM HG at 25° C.).

The production of the present invention is relatively straight forward and includes the provision of an over laminate sheet or piece which may be pre-printed using high quality imaging or printing on one or both faces. The over laminate is preferably a translucent sheet of glassine or machine glazed or machine finished paper having a thickness ranging form about 1 mil to about 3 mils. The UV curable coating may then be applied to the card base or to the over laminate sheet in a thickness ranging from about 0.001 mils to 3 mils with about 0.01 to 1 mils being preferred. The card base and over laminate are then brought together to form an intermediate laminate, one that has not been bonded together.

Once the intermediate laminate has been created the intermediate assembly is then forwarded to a curing station where at least one if not additional UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulb suitable for use in the UV curing processes, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration such as within a slurry. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention.

The structure of the laminated assembly as seen in FIG. 2 of the present invention is generally if not substantially planar, that is there are no bumps or ridges which would interfere with the processing of the laminated assembly through a non-impact printer, such as a laser printer or ink jet printer.

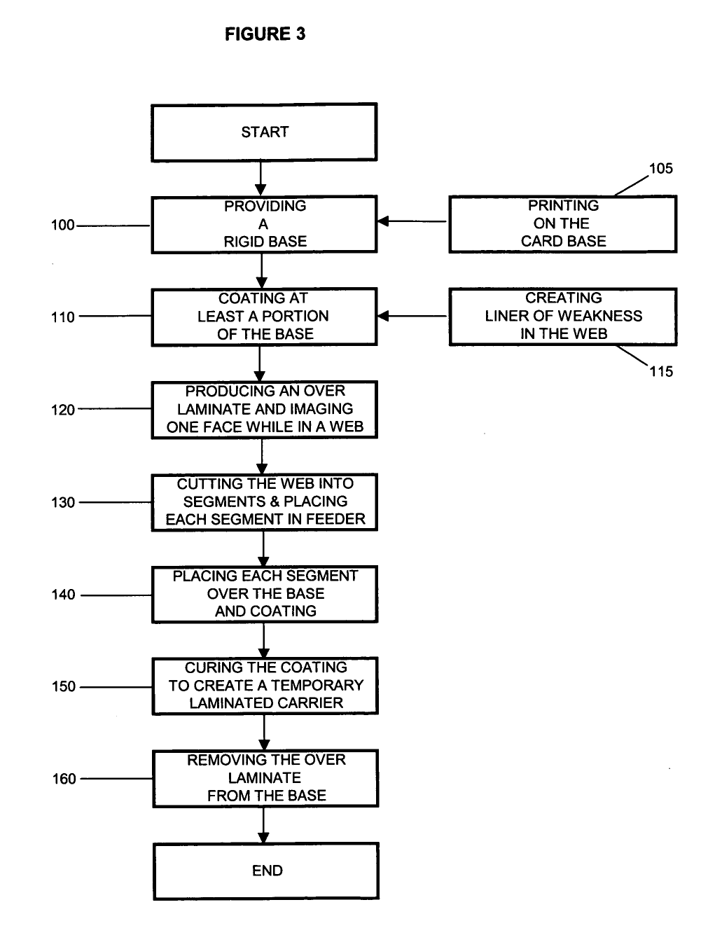

Turning now to FIG. 3 a block diagram is presented showing an exemplary method of practicing the invention and constructing the card carrier temporary laminate. The process is started and at step 100 a rigid base is provided. Preferably, the base will be a plastic or synthetic card stock but other materials that are substantially rigid such as tag or board stock made of cellulosic materials may be used. Ideally, the base material should be such that the coating will not sink into the surface of the base material and will be held out on the surface.

Next, at least a portion of the base is coated at step 110. One or both surfaces of the card may be printed at step 105 with personalized and or static information. After the base is coated with a UV curable material, an over laminate is produced at step 120. The over laminate material may be provided initially in web form and printed using a high quality imaging device as has been previously described. Once the web has been printed, the web is cut into individual segments at step 130. In addition to cutting the web into segments, it may also be desirable to produce lines of weakness in the over laminate material at step 115.

Each segment is then placed in substantial registry with the base at step 140 and then the coating is cured at step 150 to create a temporary laminated card carrier arrangement. Finally, in use, the over laminate or portions thereof may be removed such as by a user at step 160. Such portions may be used in connection with customer loyalty programs, redemption offerings and other similar type applications.

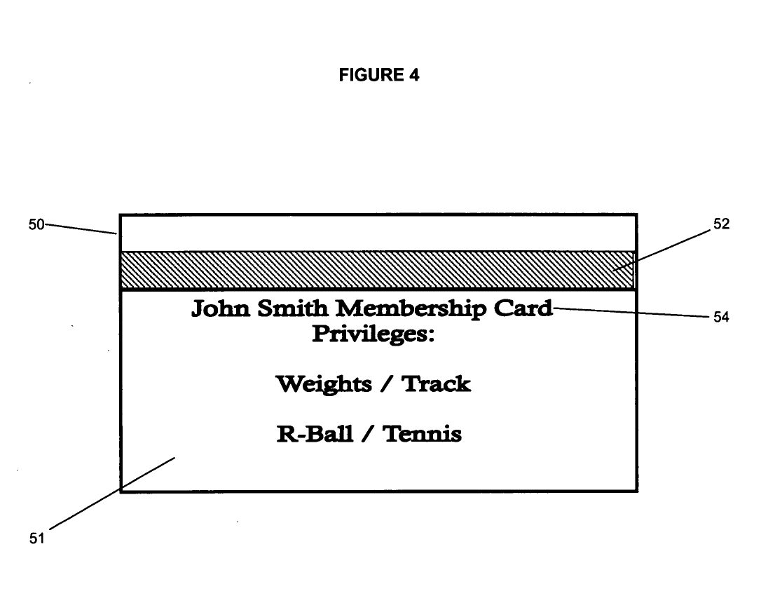

Reference is now directed at FIG. 4 of the present invention which shows the back face 51 of the card base 50. The back of the card 51 may be provided with a magnetic stripe 52 which is shown running generally parallel to the longitudinally extending side edges. In addition, the back of the card is shown with personalized printing 54.

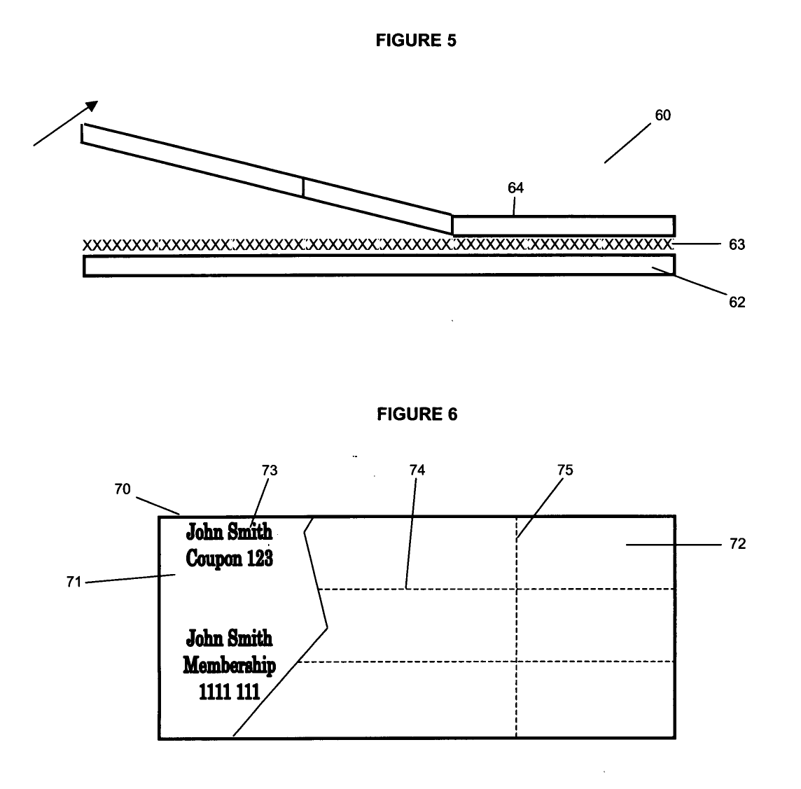

FIG. 5 provides a side view of the card carrier assembly 60 being peeled apart such that the over laminate layer 64 is peeled off from the card base layer 62 breaking the bonds of the coating 63. Once the frangible coating has been broken, the plies or layers cannot be reassembled as there is no adhesive or other tacky residue remaining on either of the layers.

FIG. 6 provides another front view of the card carrier assembly 70 showing a portion of the top or over laminate layer 72 pulled away from the surface of the card carrier layer 71. Removal of the over laminate layer 72 reveals personalized printing 73 beneath the over laminate layer and on the surface of the card carrier layer. The printing may also reveal duplicative images of the information printed on the over laminate 72 to show the user which portions had been removed from the over laminate. In addition, FIG. 6 also shows the presence of lines of weakness 74 and 75 which may be used to break apart the over laminate portion into various parts or components that may be individually presented for redemption.

It will thus be seen according to the present invention a highly advantageous temporary card carrier laminate has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A temporarily laminated card carrier assembly, comprising;
a substantially rigid card carrier base, said base having first and second faces and first and second longitudinally extending sides and first and second transversely extending edges, and at least said second face is provided with printed indicia;
a coating curable in situ is applied to said first face of said substantially rigid base said coating is applied so as to be substantially coextensive with said first and second transversely extending edges and first and second longitudinally extending sides; and
a removable over laminate that is substantially free of any adhesive residue having top and bottom faces, first and second longitudinally extending sides and first and second transversely extending edges, said top face of said over laminate is provided with printed indicia and each of said sides and edges of said over laminate being at least coextensive with said first and second longitudinally extending sides and first and second transversely extending edges of said substantially rigid base and said over laminate is applied over said curable coating to form an intermediate laminate assembly with said substantially rigid base.

2. A laminated card carrier as recited in claim 1, wherein said over laminate is provided with at least first and second lines of weakness extending between one of said first and second longitudinally extending sides and said first and second transversely extending edges.

3. A laminated card carrier as recited in claim 1, wherein said top face of said over laminate is provided with printed indicia.

4. A laminated card carrier as recited in claim 3, wherein said printed indicia on said over laminated is provided at a resolution of greater than about 150 lines per inch.

5. A laminated card carrier as recited in claim 1, wherein said first face of said rigid base is provided with indicia.

6. A laminated card carrier as recited in claim 2, wherein said lines of weakness define at least first and second areas used in a customer redemption program.

7. A laminated card carrier as recited in claim 2, wherein said first and second lines of weakness run substantially parallel to said first and second longitudinally extending sides and third and fourth lines of weakness are provided that run perpendicular to said first and second lines of weakness.

8. A laminated card carrier assembly produced in accordance with the following process;
providing a substantially rigid base, said base having top and bottom faces, first and second transversely extending edges and first and second longitudinally extending sides;
coating at least a portion of said top face of said rigid base with a curable frangible coating;
producing an over laminate by advancing a web of material in a first direction, said web having first and second faces, imaging said first face of said web with a high resolution image having greater than 150 lines per inch;
cutting said web into discrete segments and placing each of said segments into a feeder mechanism;
placing one of said segments on said rigid base and over said coating; and
curing said coating in situ by applying curing energy through said segment to create a temporarily laminated card carrier assembly having a substantially adhesive free removable over laminate.

9. A laminated card carrier assembly as recited in claim 8, wherein said curing energy is ultraviolet radiation.

10. A laminated card carrier assembly as recited in claim 8, including a further step of applying lines of weakness to each of said segments at any time producing an over laminate.

11. A laminated card carrier assembly as recited in claim 8, including a further step of printing on at least one of said top and bottom faces of said rigid base prior to the step of curing said coating.

12. A laminated card carrier assembly as recited in claim 8, wherein said coating is applied in a thickness between about 0.001 mils to about 0.003 mils.

13. A laminated card carrier assembly as recited in claim 8, including a further step of removing said over laminate from said card carrier assembly after the step of curing said coating.

14. An intermediate card shaped temporary laminate, comprising;
a card having top and bottom faces, first and second longitudinally extending sides and first and second transversely extending ends, printing applied to at least said bottom face of said card;
a coating curable in situ is applied to said top face of a said card and between said first and second longitudinally extending sides and first and second transversely extending edges, said coating covering substantially all of said top face; and
a preprinted over laminate that is substantially free of any adhesive residue having indicia provided on a top face, said printing produced in a resolution greater than about 150 lines per inch, said over laminate having first and second longitudinally extending sides and first and second transversely extending edges, said first and second transversely extending sides and first and second longitudinally extending edges of said over laminate are placed in substantial registry with said first and second longitudinally extending sides and first and second transversely extending edges of said card with said curable coating temporarily bonding said over laminate to said card.

15. An intermediate card shaped temporary laminate as recited in claim 14, wherein said over laminate permits penetration of curing energy to cure said coating in situ.

16. An intermediate card shaped temporary laminate as recited in claim 14, wherein said over laminate is provided with first and second lines of weakness extending parallel to said first and second longitudinally extending sides of said over laminate.

17. An intermediate card shaped temporary laminate as recited in claim 14, wherein said over laminate is provided with third and fourth lines of weakness extending parallel to said first and second transversely extending edges of said over laminate.

18. An intermediate card shaped temporary laminate as recited in claim 14, wherein said laminate is used in connection with a card fulfillment program.

19. An intermediate card shaped temporary laminate as recited in claim 14, wherein said over laminate is printed with personalized indicia.

20. An intermediate card shaped temporary laminate as recited in claim 14, wherein said card is provided with a magnetic strip on said bottom face and runs parallel to said first and second longitudinally extending sides of said card.
